(19) United States
(12) Patent Application Publication
(10) Pub. No.: US 2013/0218837 A1
(43) Pub. Date: Aug. 22, 2013

(54) CLOUD DATA SYNCHRONIZATION WITH LOCAL DATA

(71) Applicant: Arvin Bhatnagar, Powell, OH (US)

(72) Inventor: Arvin Bhatnagar, Powell, OH (US)

(73) Assignee: VERIZON PATENT AND LICENSING INC., Basking Ridge, NJ (US)

(21) Appl. No.: 13/534,536

(22) Filed: Jun. 27, 2012

Related U.S. Application Data
(60) Provisional application No. 61/599,662, filed on Feb. 16, 2012.

(51) Int. Cl. G06F 7/00; G06F 17/30

(52) U.S. Cl. 707/624; 707/E17.01; 707/E17.032; 707/E17.005

(57) ABSTRACT

A network device compares unique identifiers between files of a 1st dataset and a 2nd dataset. Based on the comparison, the network device determines a first set of files that includes the files of the 1st dataset that are not elements of the 2nd dataset, determines a 2nd set of files that includes the files of the 2nd dataset that are not elements of the 1st dataset, and determines a 3rd set of files that includes the files that are contained in both the 1st dataset and the 2nd dataset. The network device synchronizes the 2nd dataset with the 1st dataset based on a comparison of a temporal indicator associated with each file in the 3rd set of files to identify files contained in both the 1st dataset and the 2nd dataset having a same unique identifier but a different temporal indicator.

### CROSS REFERENCE TO RELATED APPLICATION

This application claims priority from provisional application No. 61/599,662, filed Feb. 16, 2012, the disclosure of which is incorporated by reference herein in its entirety.

### BACKGROUND

Cloud storage includes networked on-line storage where multiple virtual servers are used to store data. Operators of physical data centers virtualize their data storage resources and expose those virtualized resources to cloud storage customers as storage pools. The physical data centers may span multiple servers across multiple regions in the Internet. The use of cloud storage by customers enables the customers to offload storage maintenance tasks to the cloud storage service providers, thus, reducing information technology (IT) and data storage hosting costs.

### BRIEF DESCRIPTION OF THE DRAWINGS

FIGS. 1A and 1B are diagrams that depict an exemplary network environment in which a cloud storage dataset is synchronized with a locally stored dataset;

FIG. 2 is a diagram that depicts exemplary components of the cloud synchronization server of FIGS. 1A and 1B;

FIG. 3 is a diagram of an exemplary file and its associated attributes that may be stored in the cloud storage dataset or the local dataset of FIG. 1A;

FIGS. 4A and 4B are flow diagrams that illustrate an exemplary process for comparing and synchronizing a cloud storage dataset stored in cloud storage with a local dataset stored at a device;

FIG. 5 is a diagram of a specific example of attributes associated with an exemplary file;

FIG. 6 is a diagram of a specific example of unique persistent identifiers associated with multiple files in a dataset;

FIG. 7 is a diagram that graphically depicts the determination of files to add to the cloud storage dataset based on a comparison of the files in the cloud storage dataset and the local dataset;

FIG. 8 is a diagram that graphically depicts the determination of files to delete from the cloud storage dataset based on a comparison of the files in the cloud storage dataset; and

FIG. 9 is a diagram that graphically depicts the determination of files to update in the cloud storage dataset.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

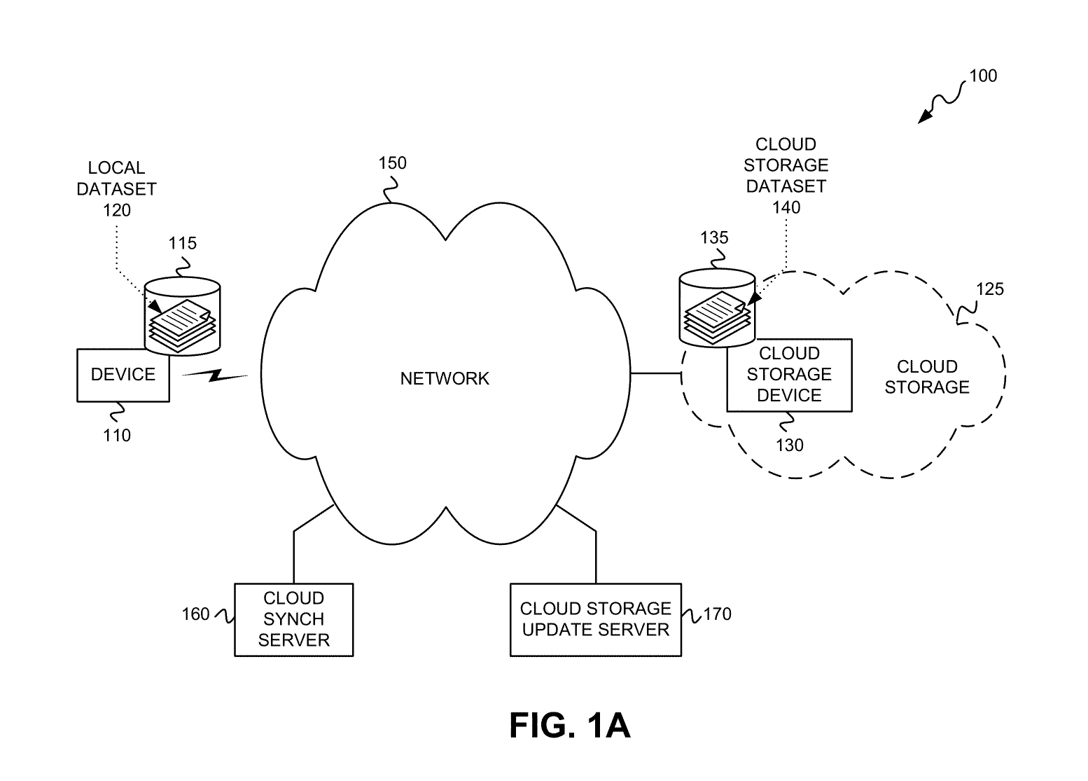

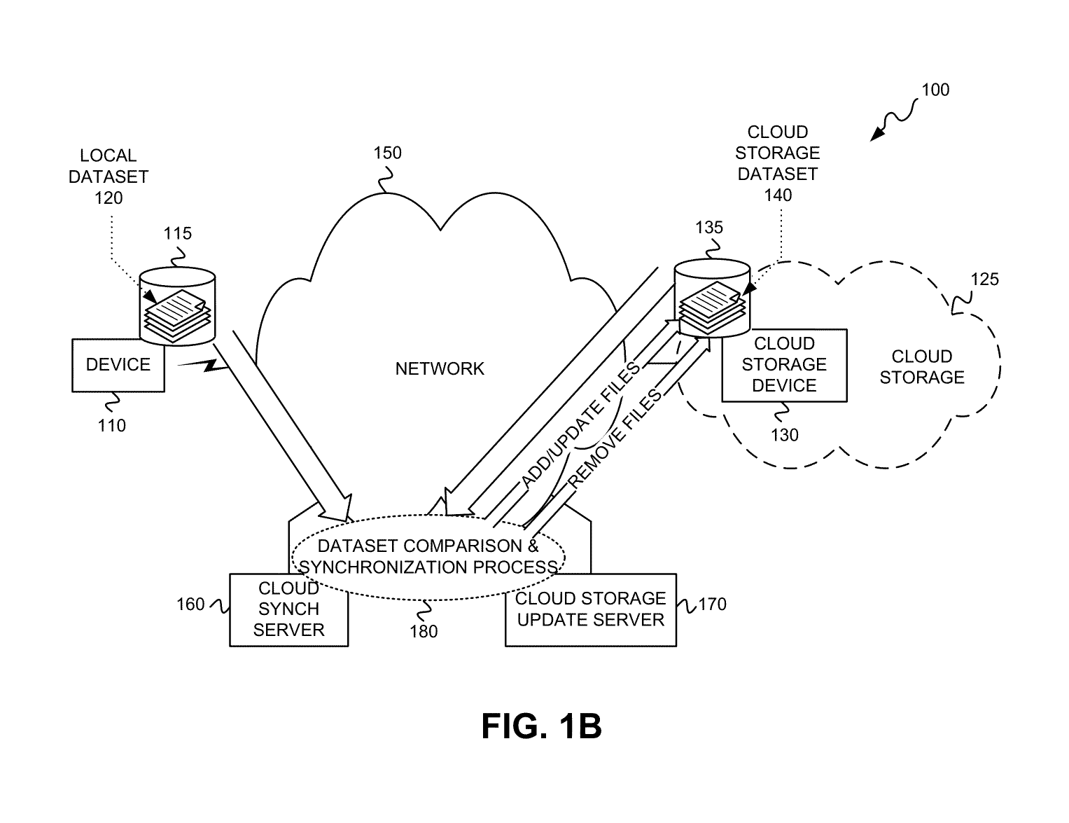

FIG. 1A illustrates an exemplary network environment 100 in which a dataset stored in cloud storage can be synchronized with a dataset stored in a local device. Network environment 100 may include a device 110, a data structure 115 storing a local dataset 120, cloud storage 125, a cloud storage device 130, a data structure 135 storing a cloud storage dataset 140, a network 150, a cloud synchronization (synch) server 160, and a cloud storage update server 170.

Device 110 may include, for example, a telephone (e.g., smart phone); a laptop, desktop, palmtop or tablet computer; a personal digital assistant (PDA), or other type of digital computing device that may store data structure 115, and which may communicate with cloud synch server 160 and cloud storage device 130 via network 150. Data structure 115 may include any type of data structure that may organize and store data, such as, for example, a database. Local dataset 120, stored in data structure 115, may include a set of data stored locally at device 110. Local dataset 120 may include, but is not limited to, a media library (e.g., audio or video media). Local dataset 120 may include any collection of any type of data stored locally at device 110.

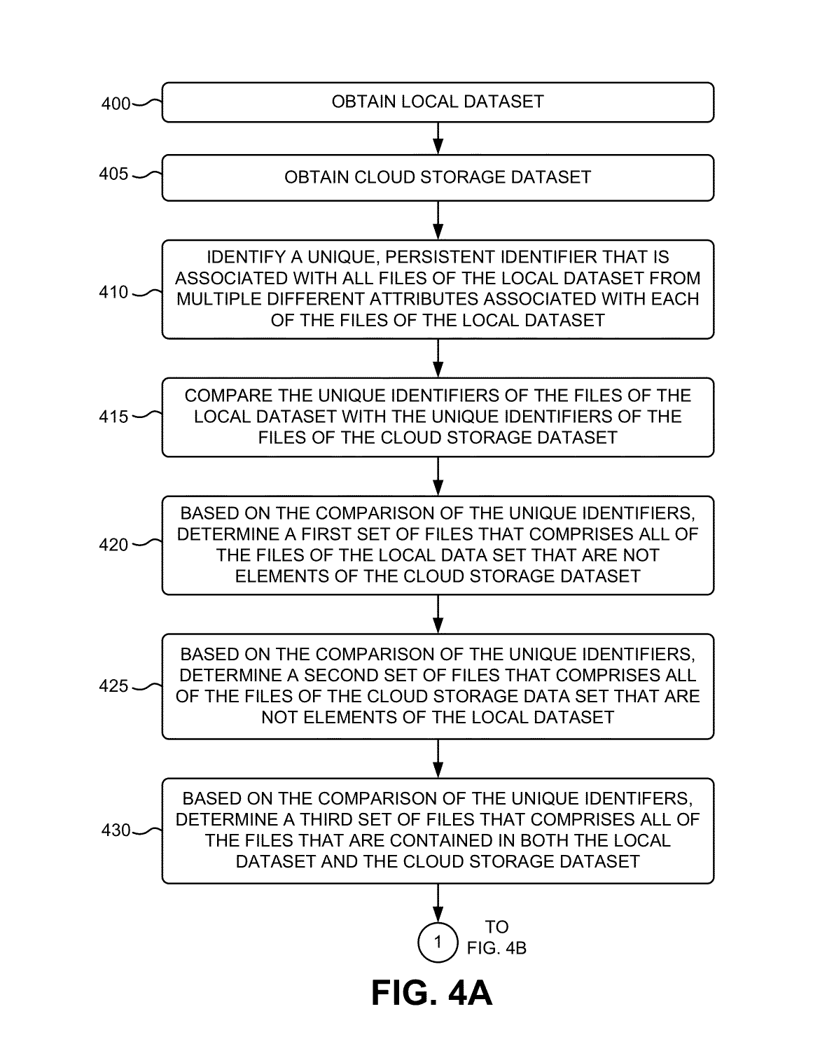

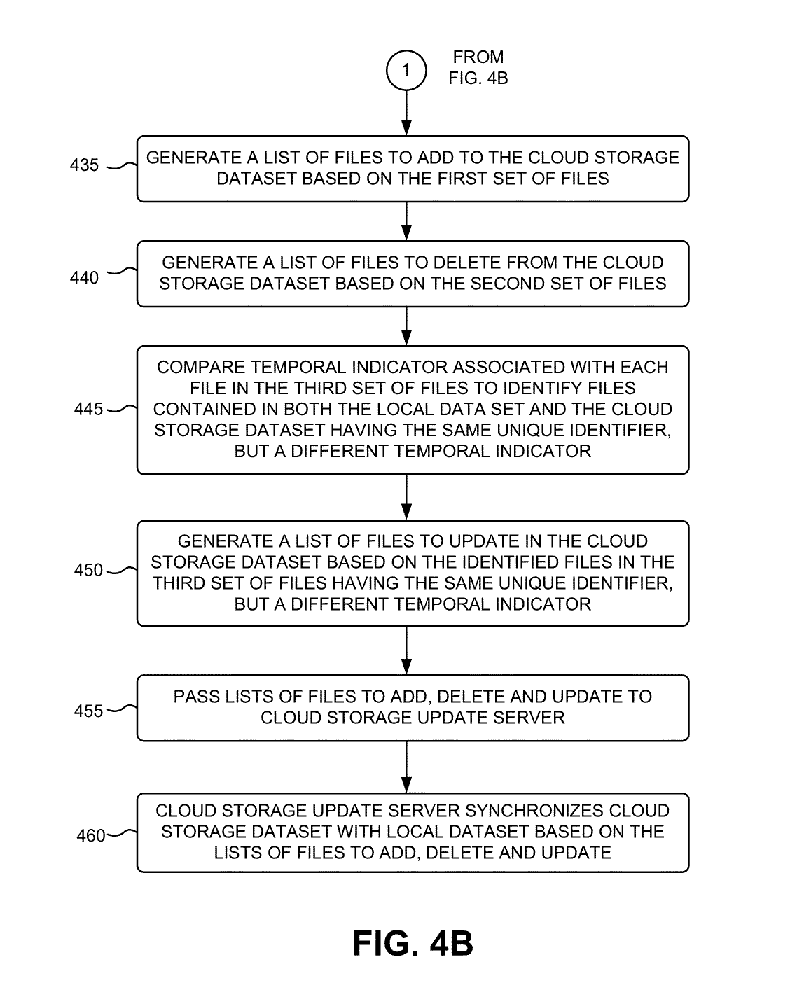

Cloud storage 125 may include multiple networked on-line storage devices for remote storage of data. Cloud storage device 130, shown in FIG. 1A, may be one of the storage devices of cloud storage 125. Cloud storage device 130 may include a server, computing device, or other network device that stores data structure 135 for storing data within cloud storage 125. Cloud storage device 130 may store a copy of local dataset 120, as cloud storage dataset 140, in data structure 135. Cloud storage dataset 140 may be continuously, periodically, or intermittently synchronized with local dataset 120 such that cloud storage dataset 140 includes an updated, faithful or accurate copy of local dataset 120. Changes in local dataset 120 at device 110, thus, are eventually copied over into cloud storage dataset 140 via a synchronization process, described below with respect to FIGS. 4A and 4B. Data structure 135 may include any type of data structure that may organize and store data, such as, for example, a database.

Cloud synch server 160 includes a network device that may perform a comparison and synchronization process which compares cloud storage dataset 140 with local dataset 120 such that cloud storage dataset 140 can be synchronized with local dataset 120. Synchronization of cloud storage dataset 140 with local dataset 120 ensures that a faithful, or up-to-date/accurate, copy of local dataset 120 is maintained in cloud storage dataset 140. Cloud synch server 160 may, based on the comparison and synchronization process, generate lists of data files that need to be added, deleted and/or updated in cloud storage dataset 140 to ensure that dataset 140 is maintained as a faithful or accurate copy of local dataset 120. In one implementation, cloud synch server 160 may generate a list of data files to add to cloud storage dataset 140, a list of data files to delete from cloud storage dataset 140, and a list of data files to update in cloud storage dataset 140. Cloud synch server 160 may pass the generated lists to cloud storage update server 170 for completion of the synchronization process.

Cloud storage update server 170 includes a network device that may receive the lists generated by cloud synch server 160 and may add, delete and/or update files stored in cloud storage dataset 140 based on the lists received from cloud synch server 160. In some implementations, cloud storage update server 170 and cloud synch server 160 may be the same network device. In other implementations, servers 170 and 160 may be separate network devices.

Network 150 may include one or more networks of various types. For example, network 150 may include a cable network (e.g., an optical cable network), a wireless satellite network, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., a Public Switched Telephone Network (PSTN)), a local area network (LAN), a wide area network (WAN), a metropolitan area network (MAN), an intranet, and/or the Internet.

The configuration of network components of network environment 100 illustrated in FIG. 1A is for illustrative purposes. Other configurations may be implemented. Therefore, network environment 100 may include additional, fewer and/or different components than those depicted in FIG. 1A.

FIG. 1B depicts cloud storage dataset 140, stored in data structure 135 in cloud storage device 130, being compared with local dataset 120, stored in data structure 115 at device 110, in a dataset comparison and synchronization process 180. As shown in FIG. 1B, process 180 may result in the addition of files to, or the updating of files within, cloud storage dataset 140. Files that are contained in local dataset 120, but not in cloud storage dataset 140, can be added to cloud storage dataset 140 during the synchronization process. Files that are contained in both local dataset 120 and cloud storage dataset 140, and that have different temporal indicators (e.g., “date/time last modified” indicators), may be updated in cloud storage dataset 140 such that cloud storage dataset 140 contains the most recent version of any file contained in local dataset 120. Files that are contained in cloud storage dataset 140, but not in local dataset 120, may be deleted from cloud storage dataset 140. Execution of process 180 may, thus, result in the continuous, periodic or intermittent synchronization of cloud storage dataset 140 with local dataset 120.

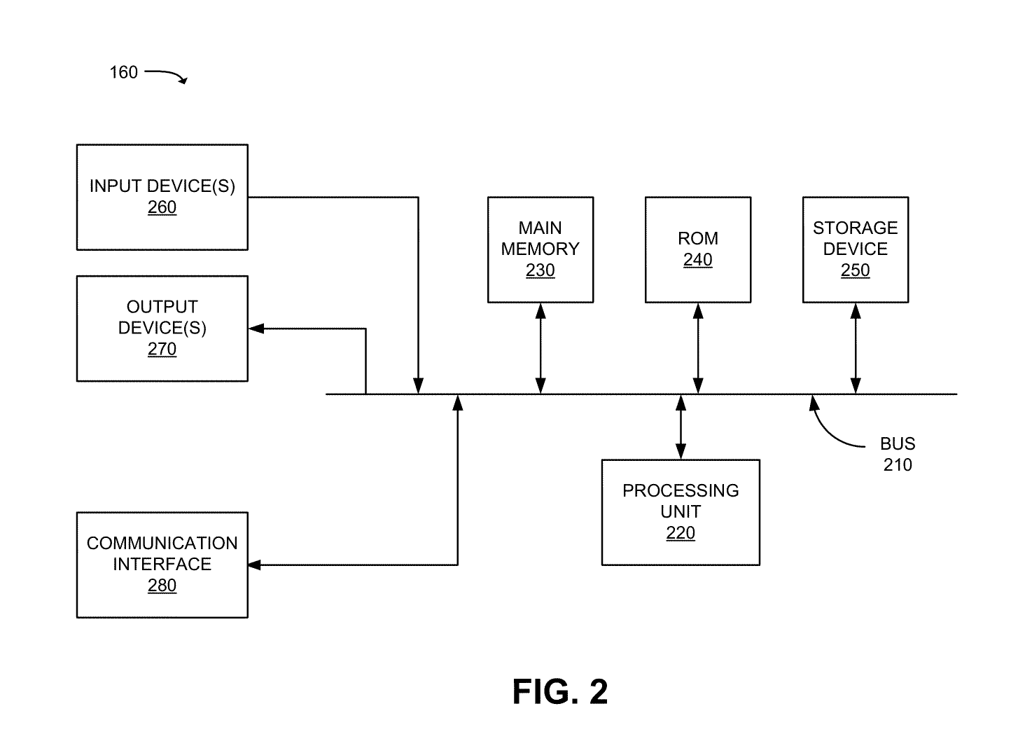

FIG. 2 is a diagram that depicts exemplary components of cloud synch server 160. Cloud storage update server 170, device 110, and cloud storage device 130 may be similarly configured. Cloud synch server 160 may include a bus 210, a processing unit 220, a main memory 230, a read only memory (ROM) 240, a storage device 250, an input device(s) 260, an output device(s) 270, and a communication interface(s) 280. Bus 210 may include a path that permits communication among the elements of server 160.

Processing unit 220 may include one or more processors or microprocessors, or processing logic, which may interpret and execute instructions. Main memory 230 may include a random access memory (RAM) or another type of dynamic storage device that may store information and instructions for execution by processing unit 220. ROM 240 may include a ROM device or another type of static storage device that may store static information and instructions for use by processing unit 220. Storage device 250 may include a magnetic and/or optical recording medium.

Input device 260 may include one or more mechanisms that permit an operator to input information to server 160, such as, for example, a keypad or a keyboard, a display with a touch sensitive panel, voice recognition and/or biometric mechanisms, etc. Output device 270 may include one or more mechanisms that output information to the operator, including a display, a speaker, etc. Communication interface(s) 280 may include a transceiver that enables server 160 to communicate with other devices and/or systems. For example, communication interface(s) 280 may include wired or wireless transceivers for communicating via network 150.

The configuration of components of server 160 illustrated in FIG. 2 is for illustrative purposes. Other configurations may be implemented. Therefore, server 160 may include additional, fewer and/or different components than those depicted in FIG. 2.

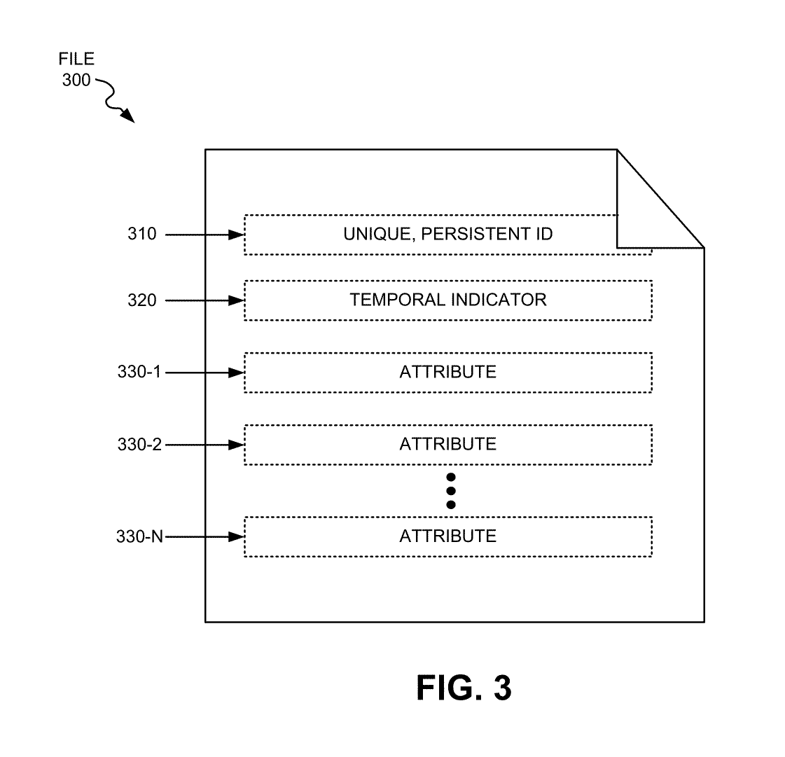

FIG. 3 depicts an exemplary data file 300, and associated attributes, that may be stored in local dataset 120 and/or cloud storage dataset 140. As shown in FIG. 3, file 300 may include multiple different attributes, such as a unique, persistent identifier (ID) 310, a temporal indicator 320, and attributes 330-1 through 330-N.

Unique ID 310 may include any type of attribute that may serve as a persistent and unique identifier of data file 300. For example, unique ID 310 may include a unique number or a unique alphabetic or alphanumeric string that is associated with file 300 in a persistent fashion. In one exemplary implementation, if local dataset 120 includes an audio library, and file 300 includes an audio track, then unique ID 310 may include a unique track ID associated with file 300.

Temporal indicator 320 may include any type of attribute that has a temporal dimension. Temporal indicator 320 may include an attribute that indicates a time associated with a last time that file 300 was modified or stored. In one implementation, temporal indicator 320 may include a date and/or time that file 300 was last modified or stored with the dataset. The time may include an hour, minute and/or second that file 300 was last modified or stored with the dataset. Attributes 330-1 through 330-N may include one or more other attributes or properties that are associated with file 300. Attributes 330-1 through 330-N may include any type of attribute, other than ID 310 and indicator 320, that may be associated with file 300. For example, if file 300 includes an audio file, attributes 330- through 330-N may include a total data size attribute, a total time attribute, an artist identifier attribute, and an album attribute.

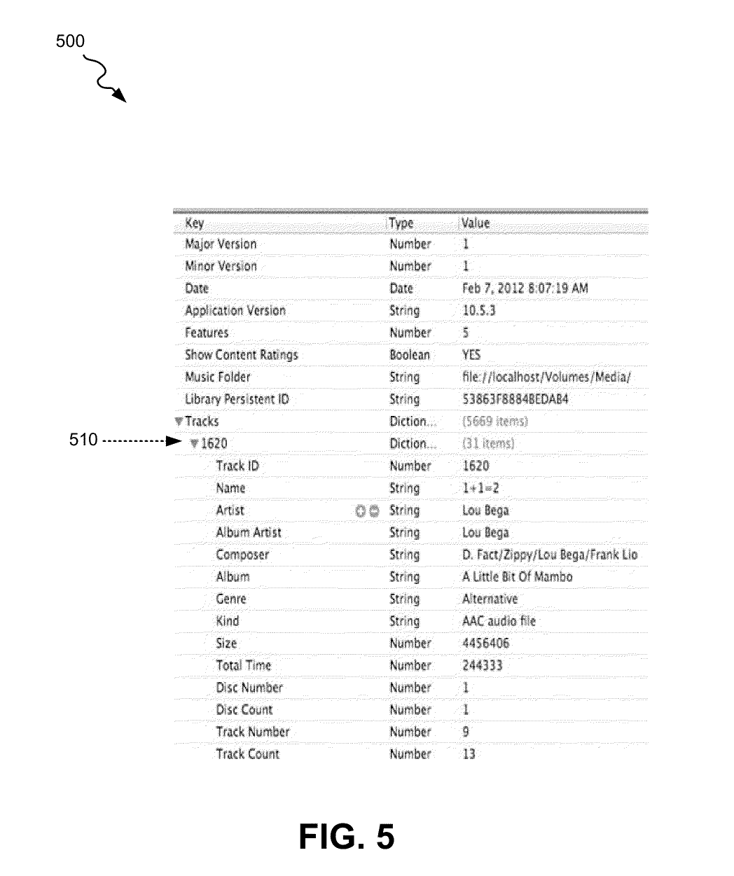

FIGS. 4A and 4B are flow diagrams that illustrate an exemplary process for comparing and synchronizing cloud storage dataset 140 stored in cloud storage 125 with local dataset 120 stored at device 110. The exemplary process of FIGS. 4A and 4B may correspond to process 180 depicted in FIG. 1B. In one implementation, the exemplary process of FIGS. 4A and 4B may be implemented by server 160, in conjunction with server 170, cloud storage device 130 and/or device 110. In another implementation, the exemplary process of FIGS. 4A and 4B may be implemented by device 110, in conjunction with cloud storage device 130. The exemplary process of FIGS. 4A and 4B is described below with reference to the example diagrams of FIGS. 5-9. The process of FIGS. 4A and 4B may, for example, be performed automatically at period intervals (e.g., every hour, day, week, etc.). Alternatively, the process of FIGS. 4A and 4B may be performed based on manual initiation by a cloud storage user, or by network administration personnel. In some implementations, the synchronization of cloud storage dataset 140 with local dataset 120 may be set or configured by the cloud storage user, or by network administration personnel based, for example, on how much the user pays to have the date synchronized.

The exemplary process may include cloud synch server 160 obtaining local dataset 120 (block 400) and obtaining cloud storage dataset 140 (block 405). Cloud synchronization server 160 may receive, via network 150, a copy of local dataset 120 from device 110, and a copy of cloud storage dataset 140 from cloud storage device 130, for use in synchronizing cloud storage dataset 140 with local dataset 120. Cloud synch server 160 may identify a unique, persistent identifier that is associated with each of all files of local dataset 120 from multiple different attributes associated with each of the files of local dataset 120 (block 410). The unique identifier includes an attribute that each of the files of local dataset 120 has, that is persistently associated with each of the files. Each of the files has a different and unique persistent identifier relative to the unique identifier of every other file. FIG. 5 depicts a specific example of attributes 500 associated with a file, where the file includes an audio file in an audio library. As shown in FIG. 5, attributes 500 of the file include a track ID 510 that uniquely identifies a specific audio track stored in the audio library. Each audio file in the audio library has a unique track ID to uniquely identify that track relative to all other tracks.

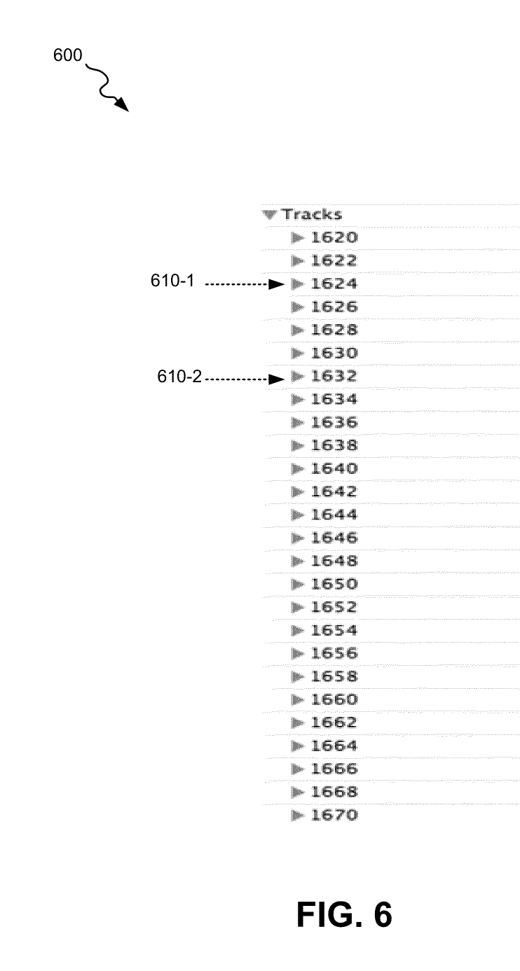

Cloud synch server 160 may compare the unique identifiers of the files of local dataset 120 with the unique identifiers of the files of cloud storage dataset 140 (block 415). FIG. 6 depicts an example of a track ID list 600 associated with an audio library. As shown, list 600 may include multiple different audio tracks, with each having its own unique ID 610 (only 610-1 and 610-2 labeled). List 600, associated with files stored in cloud storage dataset 140, may be compared with a counterpart list (not shown) stored in local dataset 120. In a simplified example, if local dataset 120 has five files having the unique IDs: {1, 2, 3, 4, 5} and cloud storage dataset 140 has six files having the unique IDs: {2, 3, 5, 6, 8, 9}, then the unique IDs 1, 2, 3, 4 and 5 of local dataset 120 may be compared with each of the unique IDs 2, 3, 5, 6, 8 and 9 of cloud storage dataset 140 to identify any matching IDs.

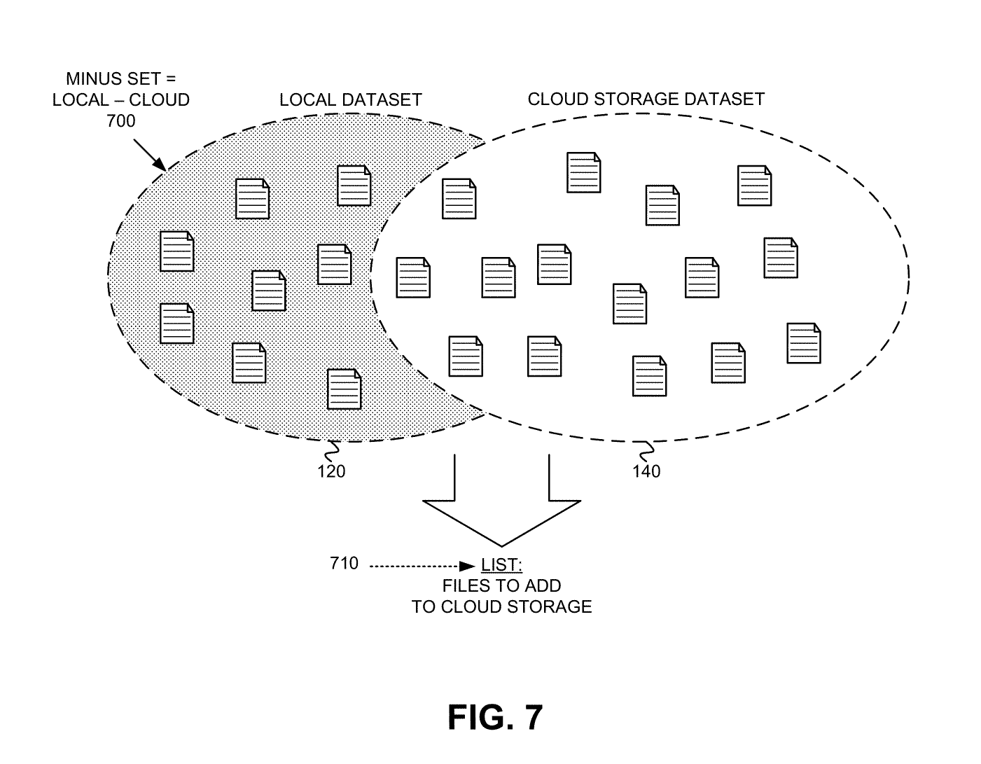

Cloud synch server 160, based on the comparison of the unique identifiers performed in block 415, may determine a first set of files that includes all of the files of local dataset 120 that are not elements of cloud storage dataset 140 (block 420). FIG. 7 graphically depicts an example of the comparison and determination of block 420. The shaded region shown in FIG. 7 includes the minus set 700 which comprises the elements of cloud storage dataset 140 subtracted from the elements of local dataset 120. Minus set 700, therefore, includes all of the files in local dataset 120 that are not contained in cloud storage dataset 140. Returning to the simplified example, if local dataset 120 has five files having the unique IDs: {1, 2, 3, 4, 5} and cloud storage dataset 140 has six files having the unique IDs: {2, 3, 5, 6, 8, 9}, then a comparison of the two datasets results in a determination of a minus set that includes {1, 4}. This minus set includes all of the files in set {1, 2, 3, 4, 5} that are not contained in set {2, 3, 5, 6, 8, 9}.

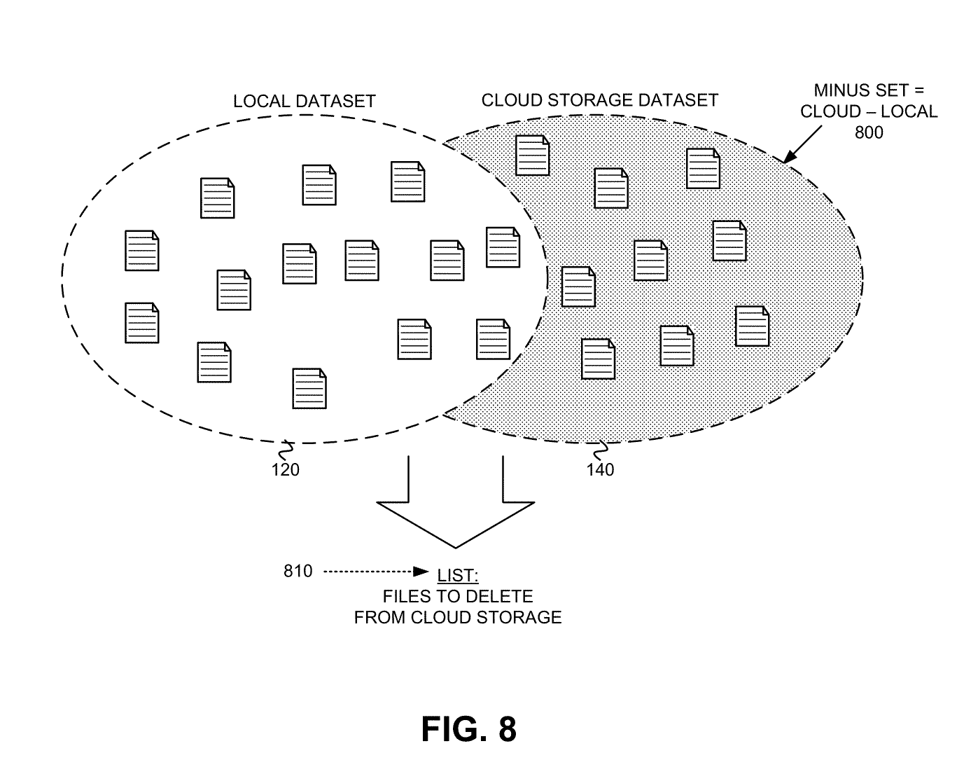

Cloud synch server 160, based on the comparison of the unique identifiers performed in block 415, may determine a second set of files that includes all of the files of cloud storage dataset 140 that are not elements of local dataset 120 (block 425). FIG. 8 graphically depicts an example of the comparison and determination of block 425. The shaded region shown in FIG. 8 includes the minus set 800 which includes the elements of local dataset 120 subtracted from the elements of cloud storage dataset 140. Minus set 800, therefore, includes all of the files in cloud storage dataset 140 that are not contained in local dataset 120. Returning to the simplified example, if local dataset 120 has five files having the unique IDs: {1, 2, 3, 4, 5} and cloud storage dataset 140 has six files having the unique IDs: {2, 3, 5, 6, 8, 9}, then a comparison of the two datasets results in a determination of a minus set that includes {6, 8, 9}. This minus set includes all of the files in set {2, 3, 5, 6, 8, 9} that are not contained in set {1, 2, 3, 4, 5}.

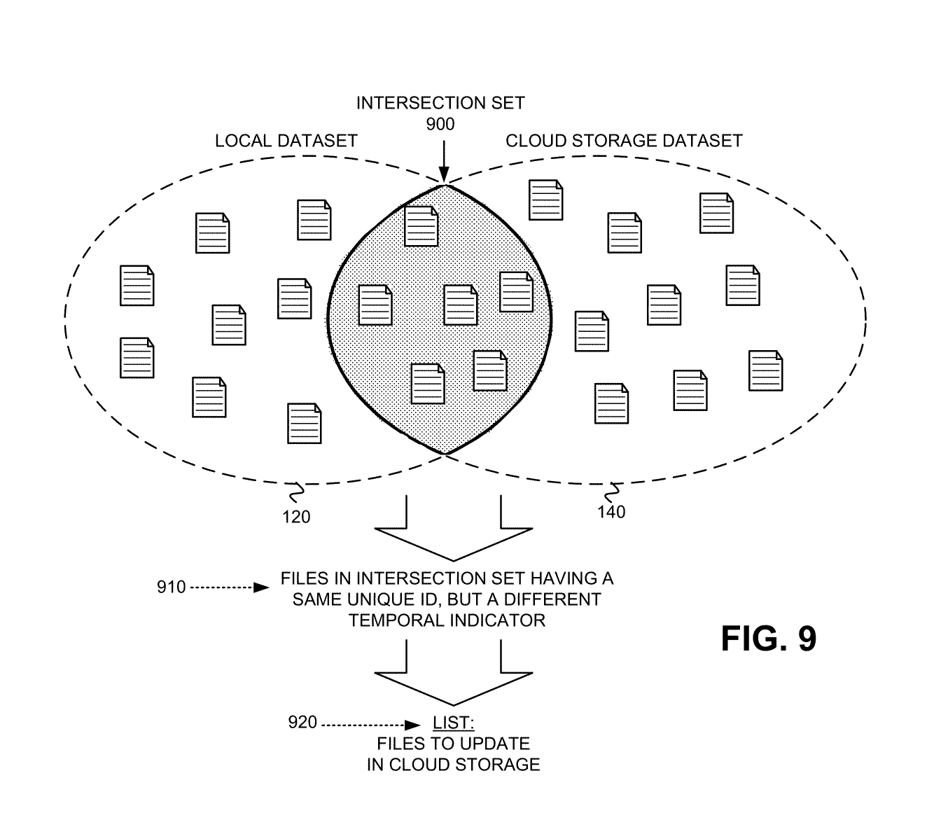

Cloud synch server 160, based on the comparison of the unique identifiers performed in block 425, may determine a third set of files that comprises all of the files that are contained in both local dataset 120 and cloud storage dataset 140 (block 430). FIG. 9 graphically depicts an example of the comparison and determination of block 430. The shaded region shown in FIG. 9 includes an intersection set 900 which comprises the elements of local dataset 120 and cloud storage dataset 140 that the datasets both have in common. Intersection set 900, therefore, includes all of the files that are contained in both local dataset 120 and cloud storage dataset 140. Returning to the simplified example, if local dataset 120 has five files having the unique IDs: {1, 2, 3, 4, 5} and cloud storage dataset 140 has six files having the unique IDs: {2, 3, 5, 6, 8, 9}, then a comparison of the two datasets results in a determination of an intersection set that includes {2, 3, 5}. This intersection set includes all of the files that are common to both of sets {2, 3, 5, 6, 8, 9} and {1, 2, 3, 4, 5}.

Cloud synch server 160 may generate a list of files to add to cloud storage dataset 140 based on the first set of files determined in block 420 (block 435). Referring to the example of FIG. 7, a list 710 of files to add to cloud storage dataset 140 is generated by populating list 710 with all of the files contained in minus set 700. Cloud synch server 160 may generate a list of files to delete from cloud storage dataset 140 based on the second set of files determined in block 425 (block 440). Referring to the example of FIG. 8, a list 810 of files to delete from cloud storage dataset 140 is generated by populating list 810 with all of the files contained in minus set 800.

Cloud synch server 160 may compare temporal indicator 320 associated with each file 300 in the third set of files determined in block 430 to identify files contained in both local dataset 120 and cloud storage dataset 140 having the same unique identifier, but a different temporal indicator (block 445). Referring to the example of FIG. 9, each of the matching files in intersection set 900, that is contained in both local dataset 120 and cloud storage dataset 140, is compared one-by-one with its counterpart in the other set to determine the files 910 having a same unique ID, but a different temporal indicator. Returning to the simplified example, files of the intersection set {2, 3, 5} stored in local dataset 120 may have the corresponding temporal indicators {1/1/12; 2/3/12; 2/3/12}, whereas the files of the intersection set stored in cloud storage dataset 140 may have the corresponding temporal indicators {1/1/12; 1/1/12/ 1/1/12}. A comparison of the temporal indicators for respective files in this example determines that the files with unique IDs 3 and 5 have different temporal indicators between local dataset 120 and cloud storage dataset 140. The temporal indicators may also be more specific than just a date (i.e., include an hour, minute, and/or second).

Cloud synch server 160 may generate a list of files to update in cloud storage dataset 140 based on the identified files in the third set of files having the same unique identifier, but a different temporal indicator (block 450). Referring to the example of FIG. 9, a list 920 of files to update in cloud storage dataset 140, with the latest version of the file stored in local dataset 120, is generated by populating list 920 with all of the files 910 in intersection set 900 having a same unique ID, but a different temporal indicator.

Cloud synch server 160 may pass the lists of files to add, delete and update, generated in blocks 435, 440 and 450, to cloud storage update server 170 (block 455). Referring to the examples of FIGS. 7-9, cloud synch server 160 may pass list 710, list 810 and list 920 to cloud storage update server 170 via network 150.

Cloud storage update server 170 may synchronize cloud storage dataset 140 with local dataset 120 based on the lists of files to add/delete and update received from cloud synch server 160 (block 460). Upon receipt of list 710, cloud storage update server 170 may retrieve, from local dataset 120, all of the files identified in list 710, and may add them to cloud storage dataset 140. Upon receipt of list 810, cloud storage update server 170 may delete all of the files identified in list 810 from cloud storage dataset 140. Upon receipt of list 920, cloud storage update server 170 may retrieve, from local dataset 120, all of the files identified in list 920, and may replace the files having the same unique IDs within cloud storage dataset 140 with the files retrieved from local dataset 120.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks has been described with respect to FIGS. 4A and 4B the order of the blocks may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
obtaining a first dataset and a second dataset;
identifying a unique and different identifier that is associated with each of the files of the first dataset from multiple attributes associated with each of the files of the first dataset;
comparing the unique identifiers of files of the first dataset with the unique identifiers of files of the second dataset;
determining a first set of files that comprises all of the files of the first dataset that are not elements of the second dataset based on the comparison;
determining a second set of files that comprises all of the files of the second dataset that are not elements of the first dataset based on the comparison;
determining a third set of files that comprises all of the files that are contained in both the first dataset and the second dataset based on the comparison;
comparing a temporal indicator associated with each file in the third set of files to identify files contained in both the first dataset and the second dataset having a same unique identifier, but a different temporal indicator;
generating a list of files to update based on the identified files; and
synchronizing the second dataset with the first dataset by adding the first set of files to the second dataset, deleting the second set of files from the second dataset, and updating the second dataset with files from the first dataset that are contained in the list of files.

2. The method of claim 1, wherein the first dataset comprises a dataset stored at a computing device and wherein the second dataset comprises a dataset stored at a cloud storage device in cloud storage.

3. The method of claim 2, wherein the computing device comprises one of a telephone; a laptop, desktop, palmtop or tablet computer; or a personal digital assistant (PDA).

4. The method of claim 1, wherein generating the list of files to update comprises:
populating the list of files with the identified files contained in both the first dataset and the second dataset having a same unique identifier, but a different temporal indicator.

5. The method of claim 1, wherein updating the second dataset with files from the first dataset that are contained in the list of files comprises:
retrieving, from the first dataset, all of the files identified in the list of files; and
replacing, in the second dataset, files having a same unique identifier as the files retrieved from the first dataset with the files identified in the list of files retrieved from the first dataset.

6. The method of claim 1, wherein the unique identifier comprises an attribute from each of the files of the first dataset that is unique to each of the files and is associated with each of the files in a persistent fashion.

7. The method of claim 6, wherein the unique identifier comprises a unique alphabetic or alphanumeric string that is associated with each of the files in a persistent fashion.

8. The method of claim 1, wherein the temporal indicator comprises an attribute that indicates a time associated with a last time that a respective file was modified or stored.

9. The method of claim 8, wherein the temporal indicator further comprises a date associated with the last time that the respective file was modified or stored.

10. One or more network devices, comprising:
one or more processing units configured to:
compare unique identifiers associated with files of a first dataset with unique identifiers associated with files of a second dataset, wherein the unique identifiers each comprises an attribute from a respective file of the first dataset that is unique to the respective file and is associated with the respective file in a persistent fashion,
determine a first set of files that comprises all of the files of the first dataset that are not elements of the second dataset based on the comparison;
determine a second set of files that comprises all of the files of the second dataset that are not elements of the first dataset based on the comparison;
determine a third set of files that comprises all of the files that are contained in both the first dataset and the second dataset based on the comparison;
compare a temporal indicator associated with each file in the third set of files to identify files contained in both the first dataset and the second dataset having a same unique identifier, but a different temporal indicator; and
synchronize the second dataset with the first dataset by adding the first set of files to the second dataset, deleting the second set of files from the second dataset, and updating the second dataset with the identified files.

11. The one or more network devices of claim 10, wherein the one or more processing units are further configured to:
obtain the first dataset and the second dataset, and
identify the unique identifiers associated with files of the first dataset from multiple attributes associated with each of the files of the first dataset.

12. The one or more network devices of claim 11, wherein, when obtaining the first dataset and the second dataset, the one or more processing units are configured to:
obtain the first dataset from a computing device, and
obtain the second dataset from a cloud storage device in cloud storage,
wherein the one or more network devices, the computing device and the cloud storage device are separate and distinct devices.

13. The one or more network devices of claim 12, wherein the computing device comprises one of a telephone; a laptop, desktop, palmtop or tablet computer; or a personal digital assistant (PDA).

14. The one or more network devices of claim 10, wherein, when identifying the files contained in both the first dataset and the second dataset having a same unique identifier, but a different temporal indicator, the one or more processing units are further configured to:
populate a list of files with files contained in both the first dataset and the second dataset having a same unique identifier, but a different temporal indicator.

15. The one or more network devices of claim 14, wherein, when updating the second dataset with the identified files, the one or more processing units are further configured to:
retrieve, from the first dataset, the files contained in the list of files; and
replacing, in the second dataset, files having a same unique identifier as the files retrieved from the first dataset with the files contained in the list of files retrieved from the first dataset.

16. The one or more network devices of claim 10, wherein the unique identifier comprises a unique alphabetic or alphanumeric string that is associated with each of the files in a persistent fashion.

17. The one or more network devices of claim 10, wherein the temporal indicator comprises an attribute that indicates a time associated with a last time that a respective file was modified or stored.

18. The one or more network devices of claim 17, wherein the temporal indicator further comprises a date associated with the last time that the respective file was modified or stored.

19. A tangible non-transitory computer-readable medium containing instructions executable by at least one processing unit, the computer-readable medium comprising:
one or more instructions for comparing unique identifiers associated with files of a first dataset with unique identifiers associated with files of the second dataset;
one or more instructions for determining a first set of files that comprises all of the files of the first dataset that are not elements of the second dataset based on the comparison of the unique identifiers;
one or more instructions for determining a second set of files that comprises all of the files of the second dataset that are not elements of the first dataset based on the comparison of the unique identifiers;
one or more instructions for determining a third set of files that comprises all of the files that are contained in both the first dataset and the second dataset based on the comparison of the unique identifiers;
one or more instructions for comparing a temporal indicator associated with each file in the third set of files to identify files contained in both the first dataset and the second dataset having a same unique identifier, but a different temporal indicator; and
one or more instructions for synchronizing the second dataset with the first dataset by adding the first set of files to the second dataset, deleting the second set of files from the second dataset, and updating the second dataset with the identified files.

20. The tangible non-transitory computer-readable medium of claim 19, further comprising:
one or more instructions for obtaining the first dataset from a computing device, and
one or more instructions for obtaining the second dataset from a cloud storage device in cloud storage, wherein the one or more network devices, the computing device and the cloud storage device are different devices; and
one or more instructions for identifying the unique identifiers associated with files of the first dataset from multiple attributes associated with each of the files of the first dataset.

21. The one or more network devices of claim 19, wherein the one or more instructions for comparing the temporal indicator further comprise:
one or more instructions for populating a list of files with the identified files contained in both the first dataset and the second dataset having a same unique identifier, but a different temporal indicator.

22. The one or more network devices of claim 21, wherein the one or more instructions for updating the second dataset with the identified files further comprise:
one or more instructions for retrieving, from the first dataset, the identified files contained in the list of files; and
one or more instructions for replacing, in the second dataset, files having a same unique identifier as the files retrieved from the first dataset with the files contained in the list of files retrieved from the first dataset.
